(19) United States
(12) Patent Application Publication
(10) Pub. No.: US 2017/0219151 A1
(43) Pub. Date: Aug. 3, 2017

(54) Insertion Stop for Preventing Overinsertion in Plastic Pipe Systems

(71) Applicant: S & B Technical Products, Inc., Fort Worth, TX (US)

(72) Inventors: John T. Filer, Colorado City, CO (US); Guido Quesada, San Jose (CR)

(21) Appl. No.: 15/012,482

(22) Filed: Feb. 1, 2016

(51) Int. Cl. F16L 47/08; F16L 21/08

(52) U.S. Cl. CPC F16L 47/08; F16L 21/08

(57) ABSTRACT

A method is shown for joining and sealing a female plastic pipe end having a belled end opening to a mating male plastic pipe end having an interior surface and an exterior surface. A sealing element is installed within a groove formed in the belled end of the female pipe section. The male pipe end is then inserted into the end opening of the female pipe end so that the elastomeric sealing gasket makes sealing contact with the exterior surface of the male pipe. A control mechanism located on the exterior surface of the male pipe end controls the distance the male pipe travels longitudinally within the end opening of the female plastic pipe to prevent overinsertion of the male pipe within the female pipe opening

### BACKGROUND OF THE INVENTION

1. Field of the Invention

The present invention relates generally to the field of plastic pipe systems of the type used in the municipal water works industry and similar applications, and in particular, to methods and devices for preventing problems caused by overinsertion of the spigot pipe end within the mating belled pipe end in making a secure connection between two plastic pipes in a pipeline.

2. Description of the Related Art

Pipes are commonly used for the conveyance of fluids under pressure, as in city water lines. They may also be used as free-flowing conduits running partly full, as in drains and sewers. Pipes for conveying water in appreciable quantities have been made of steel, cast iron, concrete, ductile iron and most recently, plastic including the, various polyolefins and PVC.

It is well known in the art to extrude plastic pipes in an elongated cylindrical configuration of a desired diameter and to then cut the extruded product into individual lengths of convenient size suitable for handling, shipping and installation. In a typical application, each length of pipe is enlarged or “belled” at one end. The end opening of the belled pipe is of a sufficient diameter to mate with the next adjacent pipe section by inserting the unenlarged or “spigot” male end of the next adjacent length of pipe within the belled end opening. The inside, diameter of the belled end is formed sufficiently large to receive the mating spigot pipe end, while allowing sufficient clearance to permit the application of an elastomeric gasket, or other sealing device, designed to prevent leakage at pipe joints when a plurality of pipe lengths are joined to form a pipeline.

In addition to providing a sealing function, pipe joints such as those used in a municipal application, must also typically be provided with some sort of restraint mechanism to prevent separation and to accommodate varying pressures as well as other environmental influences.

There are various types of mechanisms which are commercially available and which are used to provide a restraining function at the pipe joint in a plastic pipe system. For example, see, U.S. Pat. No. 7,284,3 issued Oct. 23, 2007, to Jones et al., entitled “Method of Manufacturing a Seal And Restraining System” (for plastic pipe).

In addition to the problem of restraining plastic pipe joints to prevent separation of the joints in use or failure of the seal systems thereof, a separate problem is that of possible overinsertion of the male, spigot pipe end into the mating female, belled pipe end during assembly of the pipe sections into a pipeline installation. The possible problems which can result from overinsertion of the male pipe end into the female pipe end at a pipe joint have been recognized in the past. For example, see “Longitudinal Mechanics of Buried Thermoplastic Pipe: Analysis of PVC Pipes of Various Joint Types”, Rahman and Watkins, American Society of Civil Engineers Pipeline Conference 2005, Houston, Tex. Various pipeline failure analyses have been traced back to excessive stresses on the bell pipe end as a result of overinsertion of the male pipe end. This could occur, for example, where the installation contractor uses a backhoe to push several sections of plastic pipe together in forming a pipeline. Common practice is for the contractor to push up to five joints back on the pipe in forming a section of pipeline.

In spite of the fact that possible overinsertion of PVC pipe is understood to be the cause of failure in some pipeline installations, current technologies that exists to address this problem are either less than completely effective, or tend to be overly complicated or expensive.

A need exists therefore, for a method and apparatus to prevent the inadvertent overinsertion of the male, plastic pipe end within the mating female pipe end in forming a plastic pipeline.

A need also exists for such a method and apparatus which can be simply and easily implemented without greatly increasing the cost of the pipeline installation.

### SUMMARY OF THE INVENTION

It is therefore an object of the present invention to provide a method and apparatus for preventing overinserton of plastic pipe in forming sealed connections in pipeline installations which is simple in design and dependable in operation and which does not add greatly to the cost of the sealing and restraining systems presently employed in the relevant industries. In the method and apparatus of the invention, a female plastic pipe end having a belled end is both joined and sealed with a mating male plastic pipe end having an interior surface and an exterior surface. A sealing element is provided in the form of an elastomerie sealing gasket, the gasket being installed within an internal groove formed in the belled end of the female pipe section. Next, the male pipe end is inserted into the belled end of the female pipe end so that the elastomeric sealing gasket makes sealing contact with the exterior surface of the male pipe. A special control mechanism is provided for controlling the distance the male pipe travels longitudinally within the belled end of the female plastic pipe to thereby prevent overinsertion of the male pipe within the female pipe opening.

The control mechanism comprises an external stop provided on the exterior of the male plastic pipe end, the external stop being made up of an elastomeric stop ring together with an associated clamp ring The elastomerie stop ring has an interior surface and an exterior surface, the interior surface having an internal diameter which is selected to be closely received over the exterior surface of the male, spigot plastic pipe end so that the ring member frictionally engages the exterior surface. The frictional engagement of the elastomeric stop ring on the exterior surface of the male, spigot plastic pipe end allows the stop ring to slip when a predetermined level of engagement force is exerted during the assembly of the male pipe end and the female pipe end, thereby avoiding a hard interaction which could damage the male and female pipe ends. Preferably the elastomerie stop ring is formed of rubber and the associated clamp ring is formed of metal. The clamp ring can conveniently be a hose clamp.

In one preferred form, the elastomeric stop ring exterior surface has a circumferential recessed area formed between at least a leading lip region and preferably between a leading lip region and a trailing lip region. The circumferential recessed area on the exterior surface of the elastomeric stop ring forms a circumferential raceway for receiving the associated clamp ring. The leading lip region of the elastomeric stop ring is connected by an outer vertical sidewall region to a base region of the elastomeric stop ring, whereby the outer vertical sidewall region, together with the leading lip region, form a relatively thick rubber region which acts as a bumper when the belled plastic pipe end contacts the elastomeric stop ring.

A companion restraint mechanism can also be provided for the elastomeric sealing ring which allows movement of the mating male pipe relative to the belled end of the female pipe in a first longitudinal direction but which restrains movement in a second, opposite relative direction.

A method is also shown for joining and sealing a female plastic pipe end having a belled end with an end opening to a mating male plastic pipe end having an interior surface and an exterior surface. The method comprises the steps of:

providing a sealing element in the form of an elastomeric sealing gasket, the gasket being installed within a groove formed adjacent the end opening, in the belled pipe end of the female pipe section;

inserting the male pipe end into the end opening of the female pipe end so that the elastomeric sealing gasket makes sealing, contact with the exterior surface of the male pipe end;

providing a control mechanism for controlling the distance the male pipe end travels longitudinally within the end opening of the female plastic pipe end to thereby prevent overinsertion of the male pipe end within the female pipe opening, the control mechanism being an external stop provided on the exterior of the male plastic pipe end, the external stop being comprised of an elastomeric stop ring together with an associated clamp ring, as has been described.

The above as well as additional objectives, features, and advantages of the present invention will become apparent in the following detailed written description.

### BRIEF DESCRIPTION OF THE DRAWINGS

FIG. 1 is an exploded partially sectionalized view of a pipe joint in a plastic pipeline showing the sealing ring located within the female pipe end and the mating male pipe end.

FIG. 2 is a partial view of the male, spigot pipe end showing the placement of the control mechanism on the external surface of the male pipe end.

FIG. 3 is a view similar to FIG. 2, but showing the female, belled pipe end as it approaches the male pipe end in the beginning of the installation process.

FIG. 4 is a view similar to FIG. 3, but showing the completed pipe joint with the male, spigot pipe end being fully inserted into the female, belled pipe end so that the female pipe end contacts the control mechanism on the exterior surface of the male pipe end.

FIG. 5 is a perspective view of the isolated overinsertion control mechanism of the invention showing the elastomeric stop ring and its associated clamp ring.

FIG. 6 is an isolated, perspective view of the elastomeric stop ring of FIG. 5, showing the recessed circumferential region which receives the clamp ring.

FIG. 7 is a side, cross sectional view of the elastomeric stop ring of FIG. 6, taken along lines VII-VII in FIG. 6.

FIG. 8 is a side, isolated view of the clamp ring of FIG. 5.

FIG. 9 is an isolated view of the respective ends of the clamp ring of FIG. 8.

FIG. 10 is an isolated view of the retaining bolt used with the clamp ring of FIG. 8.

FIG. 11 is a graph of rubber stretch or interference of the stop ring over the male, spigot pipe end.

FIG. 12 is a graph of closed clamp clearance over the male, spigot pipe end.

FIG. 13 is a graph of closed clamp interference on the rubber of the elastomeric stop ring.

FIG. 14 is a graph of open clamp clearance over the rubber of the elastomeric stop ring.

### DETAILED DESCRIPTION OF THE PREFERRED EMBODIMENT

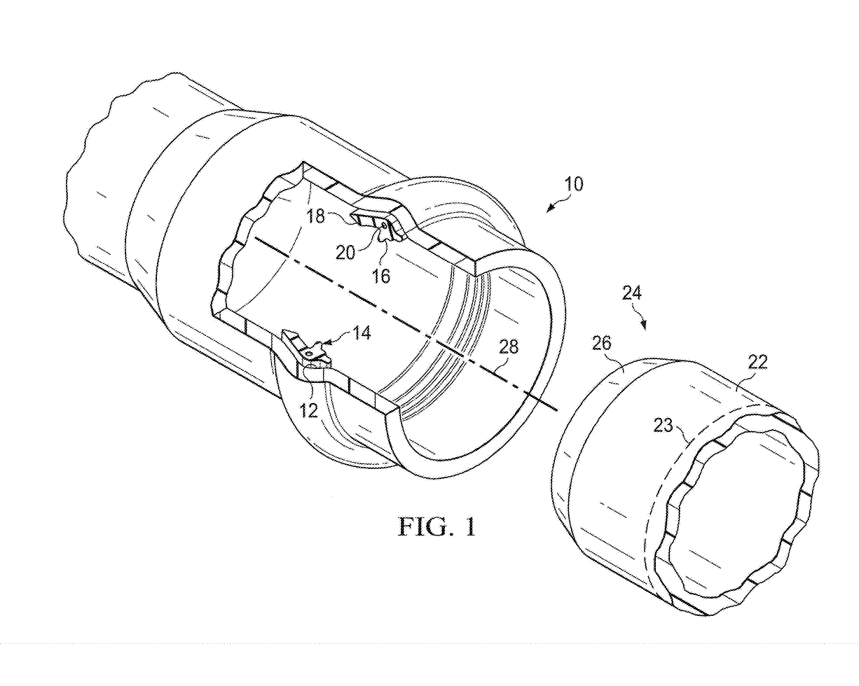

Turning to FIG. 1, there is shown an exploded view of a plastic pipe joint in which a belled, female pipe end 10 is provided with an annular groove 12 for receiving an elastomeric sealing gasket 14. The annular sealing gasket 14 is a ring shaped member which, in cross section, has a compression seal region 16 and a trailing seal region 18. The gasket may be reinforced with a steel ring 20 which circumscribes the gasket body at one circumferential location. The sealing regions 16, 18 contact the exterior surface 22 of the mating male pipe section 24 upon assembly of the joint. During the assembly process, the male, spigot pipe end 24 travels to the left along the longitudinal axis 28 of the female, bell pipe end 10. Both of the pipe sections 10, 24 are formed of PVC. In the example illustrated in FIG. 1, the mating male pipe end 24 has a chamfered lip region 26. The sealing gasket is preferably made of a resilient elastomeric, thermoplastic material. For example, the sealing gasket may be formed of natural or synthetic rubber, such as SBR, or other elastomeric materials which will be familiar to those skilled in the plastic pipe arts such as EPIM or nitrile rubber. As will be apparent from the description which follows, any number of specialized sealing rings can be utilized in order to optimize the sealing function of the assembly.

In some circumstances, a companion restraint mechanism is provided for the elastomeric sealing ring which allows movement of the mating male pipe 24 relative to the belled end 10 of the female pipe in a first longitudinal direction but which restrains movement in a second, opposite relative direction. As has been mentioned, the restraint mechanism can take the form, for example, of the device described in U.S. Pat. No. 7,284,310, issued Oct. 23, 2007, to Jones et al., and assigned to the assignee of the present invention. The restraint mechanism shown in that reference comprises a ring shaped housing having a circumferential interior region and a companion ring-shaped gripping insert which is contained within the circumferential interior region of the housing. The gripping insert has an exterior surface and an interior gripping surface with at least one row of gripping teeth for gripping the exterior surface of the male plastic pipe.

Restraint mechanism of this type are sold commercially as the Bulldog® Restraint System and will be familiar to those skilled in the plastic pipe sealing arts.

The belled pipe end 10 may be formed by the so called “Rieber” process, familiar to those skilled in the waterworks industries. In the early 1970's, a new technology was developed by Richer & Son of Bergen, Norway, referred to in the industry as the “Rieber Joint.” The Rieber system employed a combined mold element and sealing ring for sealing a joint between the socket end and spigot end of two cooperating pipes formed from thermoplastic materials. In the Richer process, the elastomeric gasket was installed within a simultaneously formed internal groove in the socket end of the female pipe during the pipe belling process. The provision of a prestressed and anchored elastomeric gasket during the belling process at the pipe factory provided an improved socket end for a pipe joint with a sealing gasket which would not twist or flip or otherwise allow impurities to enter the sealing zones of the joint, thus increasing the reliability of the joint and decreasing the risk of leaks or possible failure due to abrasion. The Richer process is described in the following issued United States patents, among others: U.S. Pat. Nos. 4,120,521; 4,061,459; 4,030,872; 3,965,715; 3,929,958; 3,387,992; 3,884,612; and 3,776,682.

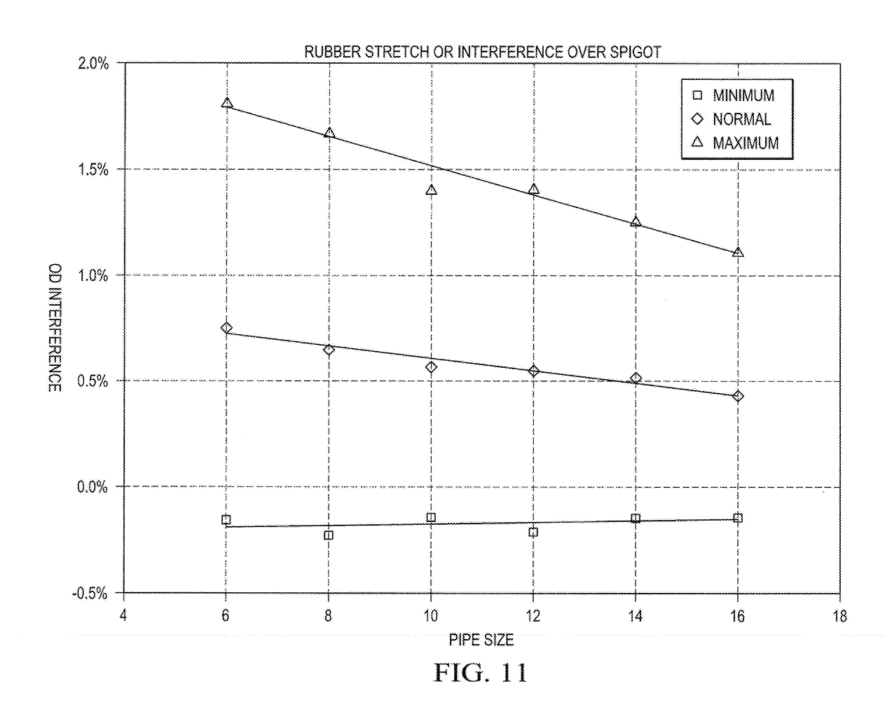

FIG. 1 of the drawings is also a simplified illustration of the forces at work during the assembly of a pipe joint in a typical plastic pipeline installation which can lead to the problem of “overinsertion.” When the spigot 24 is “stabbed” into the mating female, belled socket end 10 to make the connection, the pipes are assembled by a thrust force. At the present time in the industry, the male pipe typically has a “witness mark” on its exterior surface (shown in simplified form as 23 in FIG. 11. This mark theoretically ensures that the backhoe operator will not overinsert the male pipe into the female, belled pipe end. However, any carelessness or inadvertence on the part of the backhoe operator may result in an excessive longitudinal thrust force being applied by the spigot against the female, belled pipe end. If the connection is tight, internal pressure cannot reach the gasket. As a result, internal pressure fluctuations on the spigot cause undesirable concentrated stresses against the bell. Further, if the spigot is “jammed” into the throat of the bell during assembly of the joint, allowable joint deflection is reduced, sometimes quite dramatically.

The longitudinal thrust imposes a radial force, which wedges the bell end outwardly and may tend to shear the bell from the pipe.

As briefly mentioned, current practice is to use a “witness mark” on the exterior surface of the male, spigot pipe end in order to lessen the possibility of overinsertion during joint make up. However, in practice, even if the male pipe is only installed up to the witness mark, overinsertion can occur on the joints immediately behind the first joint. This is due to the fact that there is a peak in the assembly force during make up. When the joint reaches this peak, the force transmitted to the trailing pipes is greater than the resistance from the installed sealing gaskets. While a certain force is applied to overcome peak resistance from the sealing gasket, if the receiving pipe is not anchored, all of force is transmitted to the joint behind. The seal in the joint behind is fully installed, so it will take out at most about 50% of this force by friction. The remainder of the force is the overinsertion force.

The method of the present invention differs from the traditional practices intended to prevent overinsertion in that a special “control mechanism” is provided for controlling the distance the male pipe 24 travels longitudinally within the belled end of the female plastic pipe 10 to thereby prevent overinsertion of the male pipe within the female pipe opening.

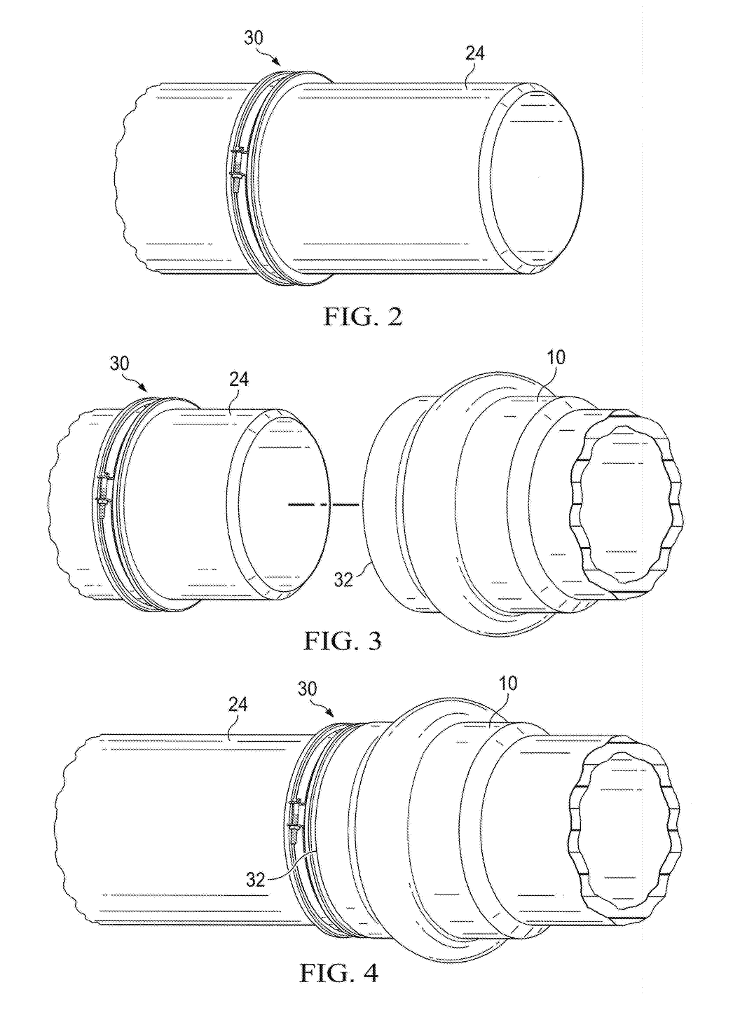

As shown in FIGS. 2-4, the “control mechanism” can take the form of an external stop (designated generally as 30) provided on the exterior surface of the male plastic pipe. FIG. 2 shows the external stop 30 on the exterior surface of the male, spigot pipe end 24. In FIG. 3, the female. belled pipe end 10 is shown shortly before the installation process begins. In FIG. 4, the external lip region 32 of the belled pipe end has contacted the external stop 30.

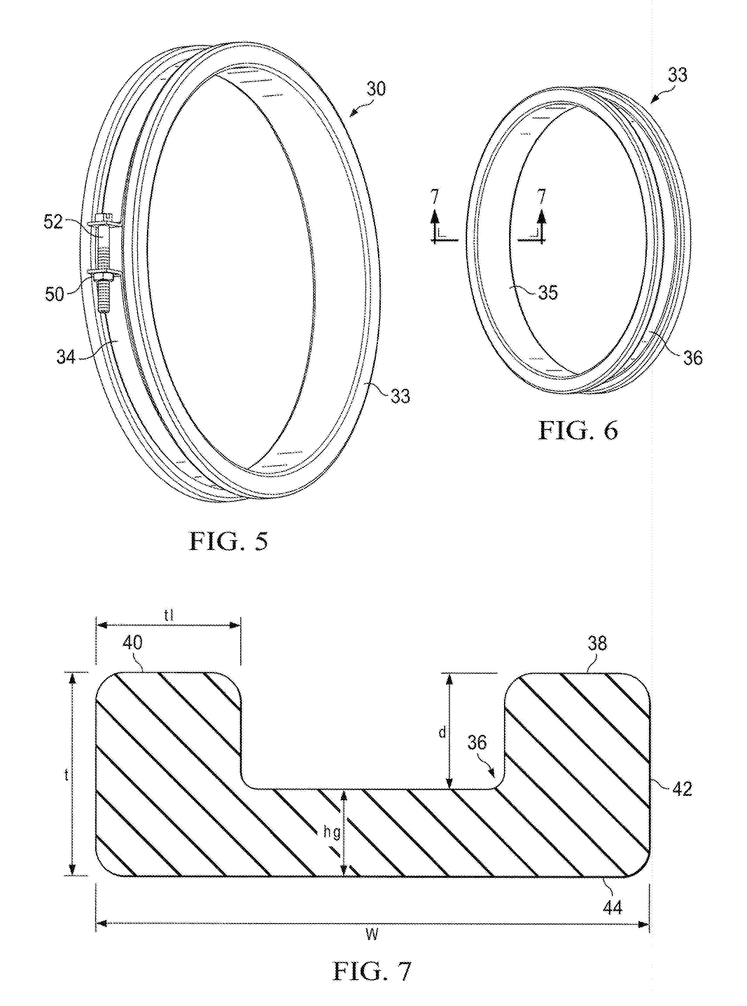

FIG. 5 shows the external stop 30 in isolated fashion. As will be appreciated, the external stop acts as a control mechanism for controlling the distance the male, spigot pipe end travels longitudinally within the end opening of the female, belled plastic pipe end to thereby prevent overinsertion of the male pipe end within the female pipe end opening. The external stop 30 is made up of an elastomeric stop ring 33 (shown in isolated fashion in FIG. 6), together with an associated clamp ring 34. As can be seen in FIG. 6, the elastomeric stop ring 33 has an interior surface 35 and an exterior surface 36. The interior surface has an internal diameter which is selected to be closely received over the exterior surface of the male, spigot plastic pipe end 24. By “closely receive” is meant that the elastomeric stop ring 33 is sized to be slid over the exterior of the male, spigot pipe end and frictionally engaged on the exterior surface.

The importance of this frictional engagement of the elastomeric stop ring 33 on the exterior surface of the male pipe end is that it allows the stop ring to slip or move longitudinally when a predetermined level of engagement force is exerted by the female pipe end during the assembly of the male pipe end and the female pipe end. This inherent safety mechanism helps to assure that damage will not occur to the belled or spigot pipe ends during assembly, as might occur where the external stop is fixed permanently or semi-permanently in place. Such a force could also result, for example, from backhoe forces, or from thermal expansion, or the like.

The elastomeric stop ring can be formed of any of a number of convenient elastomeric materials and is preferably formed of a natural or synthetic rubber, such as nitrile rubber, SBR rubber, or EPDM. The stop ring can be spliced (one piece ring) or unspliced. In one exemplary installation, the elastomeric stop ring was extruded from an SBR stock having a 40-50 ShA hardness with the ends being spliced together. The spliced ring can only be installed by sliding it from the tip of the spigot. The unspliced ring can be installed by opening the clamp ring and wrapping the rubber ring about the tip of the spigot. The type of rubber used might depend, in part, upon the environment where the plastic pipeline is expected to be used. For example, exposure to oil and fuels might require that a nitrile rubber be used.

As shown in the cross sectional view of FIG. 7, the elastomeric stop ring has a circumferential recessed area 36 formed adjacent at least a leading lip region 38. In other words, the recessed area 36 could be L-shaped in cross section. Preferably, the circumferential recessed area 36 is formed between the leading lip region 38 and a trailing lip region 40. As can be appreciated from

FIG. 5, the circumferential recessed area 36 on the exterior surface of the elastomeric stop ring 33 forms a circumferential raceway for receiving the associated clamp ring 34. With a symmetric design, the stop ring cannot be installed facing in the wrong direction. Generally speaking, the deeper the recessed area 36, the more difficult it is for the associated clamp ring 34 to slip out during handling or when tightening.

Again referring to FIG. 7, the leading lip region 38 of the elastomeric stop ring 33 is connected by an outer vertical sidewall region 42 to a base region 44 of the elastomeric stop ring. The outer vertical sidewall region 42, together with the leading lip region 38, act as a bumper when the belied plastic pipe end contacts the elastomeric stop ring 32. The relatively thick sidewall region of the stop ring provides some flexibility to the assembly as the socket reaches the insertion line and avoids any kind of hard interaction or impact which could damage the pipe socket end or the spigot pipe end.

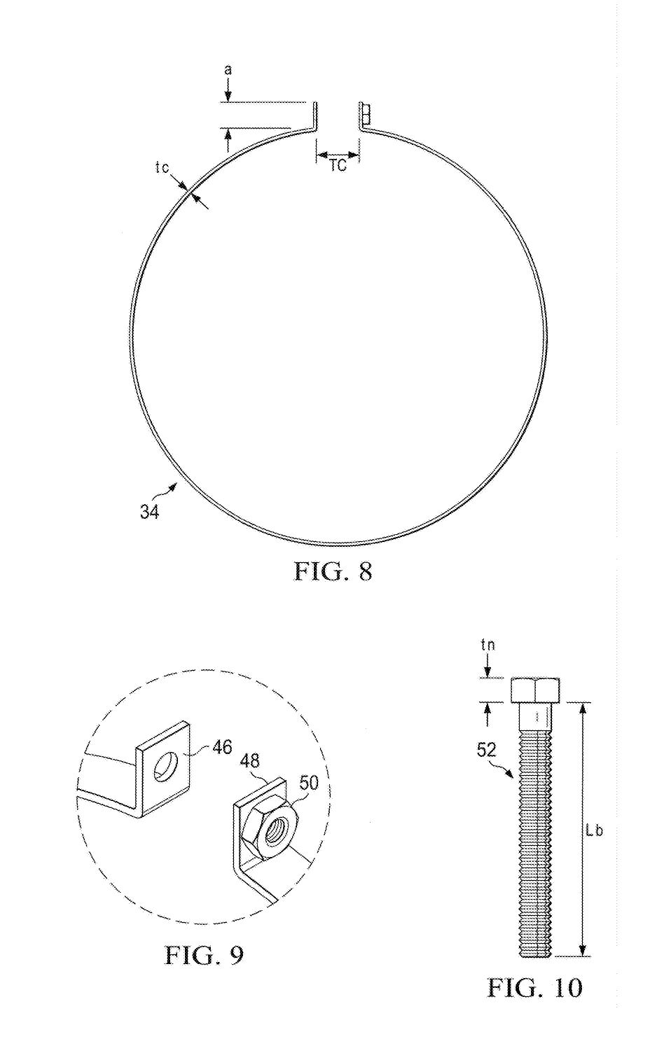

The associated clamp ring, can be formed of any convenient hard metal material, such as a commercially available steel. In some instances, the clamp ring can be a commercially available hose clamp. In the version of the invention shown in FIGS. 8 and 9, the clamp ring 34 is a simple bent steel strip having bent ends 46, 48, one of which is fitted with a welded nut 50 for receiving a mating threaded bolt 52 (FIG. 10). The threaded bolt 52 can take a variety of forms such as a hex-flanged head screw. Alternatively, the head could be cross recessed (Phillips), hexagon socket or slotted. In some cases, rather than a welded nut, a solder point is applied to the tip of the threaded bolt after the clamp ring is assembled to retain the associated nut 50. The clamp ring must be stronger and stiffer than the rubber ring in order to achieve the desired contact pressure and it must be possible to tighten it around the pipe, whether with a screw, a lever, or other means.

FIGS. 11-14 of the drawings give the results of some testing done with stop rings having the exemplary dimensions given in Table I which follows. The exemplary dimensions merely represent one set of acceptable design parameters for stop rings which come within the scope of the present invention. The dimensions designated in Table 1 are:

Rubber

t: total height

w: total width

hg: height to center of gravity

d: groove depth

tl: lateral thickness

lr: cut length

t-d; thickness

Clamp

lc: cut length including bends

a: bend length

tc: thickness

re: bend radius

Bolt and Nut

Lb: free bolt length

tn: nut thickness

tr: reduction in bolt length due to retaining weld

The performance parameters presented in Table 1 and FIGS. 11-14 are used to establish acceptable dimensions and tolerances. The information in FIGS. 11-14 is presented in terms of percentages so that they can be compared across different sizes. The parameters measured are:

Rubber stretch: Also referred to as spigot interference. It defines how much a spliced rubber part should stretch to fit snugly around the spigot.

Closed Clamp Clearance Over Spigot: Checks that the clamp ring alone (without any rubber) would not tighten directly over the spigot.

Closed Clamp Interference On Rubber: Check that the clamp ring will always be able to compress the rubber against the spigot when fully tightened.

Open Clamp Clearance Over Rubber: Checks that the clamp ring will be loose around the rubber when the nut is at the tip of the threaded bolt.

[symbol]

Cut level: S 1
Insertion Stop II
General Dimensions

| | Rubber | | | | | | | | | | | | | | | |
|---|---|---|---|---|---|---|---|---|---|---|---|---|---|---|---|---|
| | | | | | | | hg | | | | tl | | | | | |
| | t | | | w | | | Height | d | | | Lateral | | | Lr | | |
| Size | Height | | | Width | | | to cg | Depth | | | thickness | | | Cut Length | | |
| in | Num | Tol | | Num | Tol | | Ref | Num | Tol | | Num | Tol | | Num | Tol | |
| 6 | 14.0 | −1.3 | 1.3 | 38.4 | −2.0 | 2.0 | 5.8 | 8.0 | −1.0 | 1.0 | 10.0 | −1.0 | 1.0 | 583 | −5 | 5 |
| 8 | 14.0 | −1.3 | 1.3 | 38.4 | −2.0 | 2.0 | 5.8 | 8.0 | −1.0 | 1.0 | 10.0 | −1.0 | 1.0 | 754 | −6 | 6 |
| 10 | 14.0 | −1.3 | 1.3 | 38.4 | −2.0 | 2.0 | 5.8 | 8.0 | −1.0 | 1.0 | 10.0 | −1.0 | 1.0 | 917 | −6 | 6 |
| 12 | 14.0 | −1.3 | 1.3 | 38.4 | −2.0 | 2.0 | 5.8 | 8.0 | −1.0 | 1.0 | 10.0 | −1.0 | 1.0 | 1084 | −8 | 8 |
| 14 | 14.0 | −1.3 | 1.3 | 38.4 | −2.0 | 2.0 | 5.8 | 8.0 | −1.0 | 1.0 | 10.0 | −1.0 | 1.0 | 1281 | −8 | 8 |
| 16 | 14.0 | −1.3 | 1.3 | 38.4 | −2.0 | 2.0 | 5.8 | 8.0 | −1.0 | 1.0 | 10.0 | −1.0 | 1.0 | 1419 | −8 | 8 |

| | Clamp | | | | | | | | | | | | Bolt/Nut | | | |
|---|---|---|---|---|---|---|---|---|---|---|---|---|---|---|---|---|
| | Lc | | | a | | | tc | | | rc | | | | Lb | tn | tl |
| Size | Cut Length | | | Bend Length | | | Thickness | | | Bend radius | | | | Length | Thick [symbol] | lengt [symbol] |
| in | Num | Tol | | Num | Tol | | Num | Tol | | Num | Tol | | Specification | Ref | Ref | Ref |
| 6 | 599 | −1.0 | 1.0 | 15.0 | −1.0 | 1.0 | 1.8 | −0.2 | 0.2 | 1.8 | −0.2 | 0.2 | 1/4-20 UNC-2B | 50.8 | 4.0 | 2.0 |
| 8 | 771 | −1.0 | 1.0 | 15.0 | −1.0 | 1.0 | 1.8 | −0.2 | 0.2 | 1.8 | −0.2 | 0.2 | 1/4-20 UNC-2B | 50.8 | 4.0 | 2.0 |
| 10 | 935 | −1.0 | 1.0 | 15.0 | −1.0 | 1.0 | 1.8 | −0.2 | 0.2 | 1.8 | −0.2 | 0.2 | 1/4-20 UNC-2B | 50.8 | 4.0 | 2.0 |
| 12 | 1102 | −1.0 | 1.0 | 15.0 | −1.0 | 1.0 | 1.8 | −0.2 | 0.2 | 1.8 | −0.2 | 0.2 | 1/4-20 UNC-2B | 50.8 | 4.0 | 2.0 |
| 14 | 1259 | −1.0 | 1.0 | 15.0 | −1.0 | 1.0 | 1.8 | −0.2 | 0.2 | 1.8 | −0.2 | 0.2 | 1/4-20 UNC-2B | 50.8 | 4.0 | 2.0 |
| 16 | 1419 | −1.0 | 1.0 | 15.0 | −1.0 | 1.0 | 1.8 | −0.2 | 0.2 | 1.8 | −0.2 | 0.2 | 1/4-20 UNC-2B | 50.8 | 4.0 | 2.0 |

[symbol]

indicates data missing or illegible when filed

FIG. 11 is a graph of rubber stretch or interference of the stop ring over the male, spigot pipe end.
Also referred to as spigot interference
Defines
   How much a spliced rubber part should stretch to fit snugly around the spigot
   How much gap there would be, between the ends of an unspliced rubber part wrapped around the spigot
Expressed as a percentage
   Difference between internal perimeter of the rubber part and the spigot OD divided by the spigot OD
Loose rubber
   Rubber stretch below zero
   Could kink or make handling and tightening more difficult
Tight rubber
   Rubber stretch above 2%
   Makes it more difficult to slide the insertion stop into position
   In an unspliced rubber it leaves an unnecessarily large gap between the ends which exposes the metal clamp

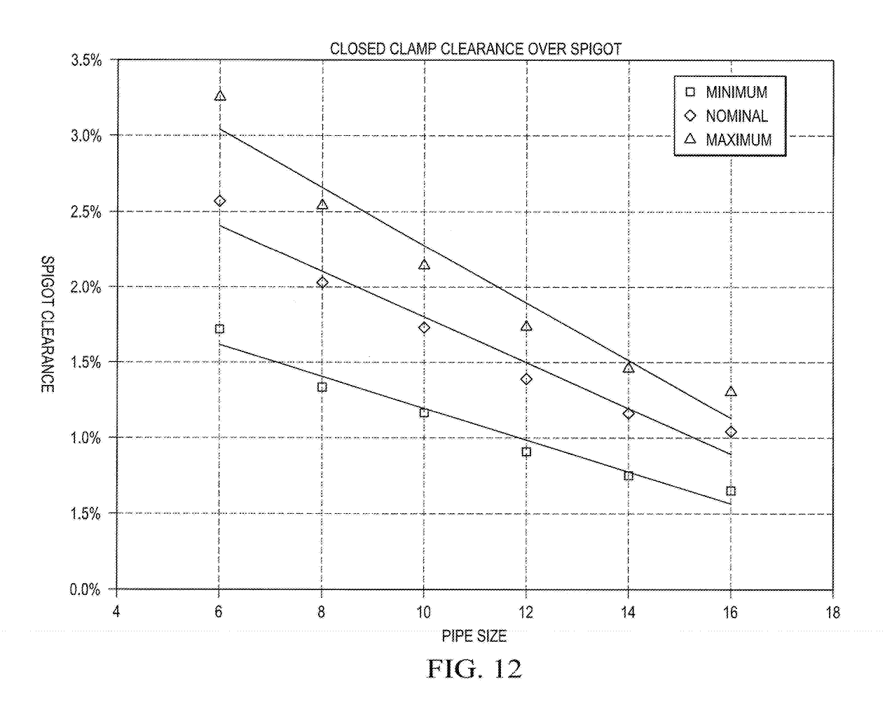

FIG. 12 is a graph of closed clamp clearance over the male, spigot pipe end.
Checks that the clamp alone (without rubber) would not tighten directly over the spigot
   To avoid damaging the pipe due to direct interaction with the steel
   To make sure clamp would not work without the rubber
   To make sure that there will always be a layer of rubber between the metal and the spigot
Expressed as a percentage
   Difference between spigot OD and closed clamp ID divided by spigot OD
Measured when the clamp is completely closed
   Rubber not taken into consideration
Tight closed clamp
   Clearance below 0.5%
   Risk of direct metal to pipe interaction
Loose closed clamp
   Not directly a problem
   However, other performance parameters such as closed rubber interference would show that the closed clamp is not tight enough around the rubber

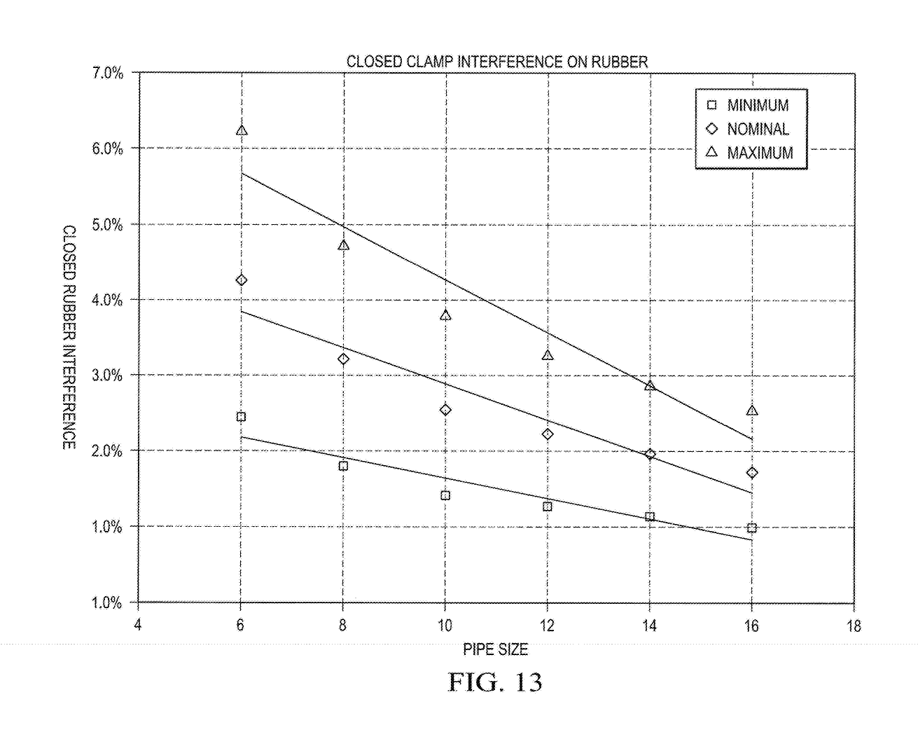

FIG. 13 is a graph of closed clamp interference on the rubber of the elastomeric stop ring.
Checks that the clamp will always be able to tighten over the rubber and the spigot
Expressed as a percentage
   Difference between the rubber ID when compressed inside a closed clamp and the spigot OD, divided by the spigot OD
Measured when the clamp is completely closed
Rubber thickness (t-d) taken into consideration
Tight closed clamp
   Interference above 5%
   Not critical
   It could be an indication that the open clearance and the bolt length are is larger than necessary
   It could allow a user to tighten the clamp too much
Loose closed clamp
   Interference below 1%
   Risk of not being able to tighten the clamp properly

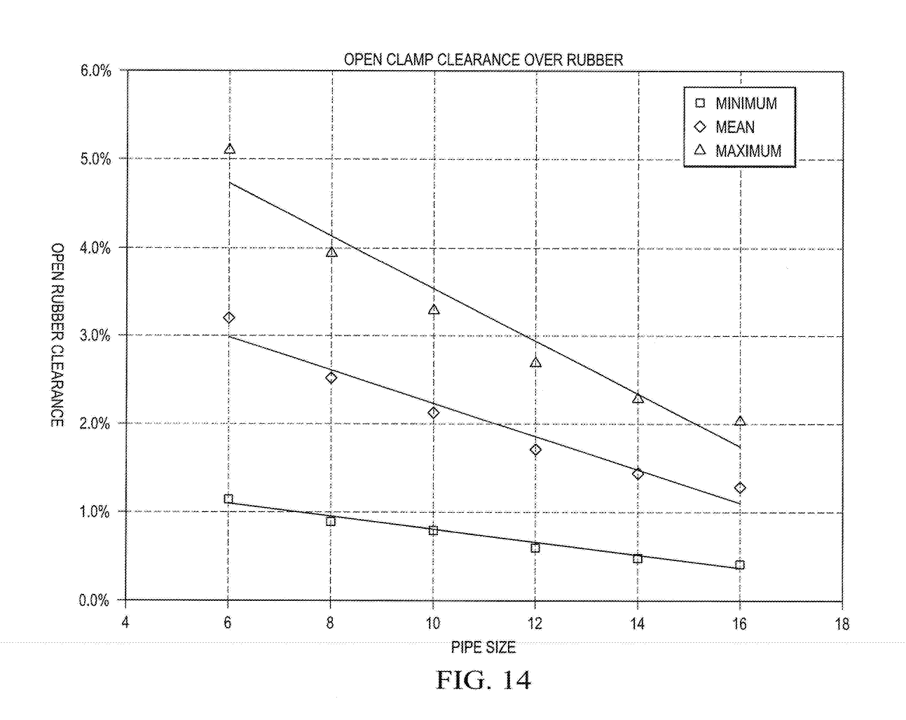

FIG. 14 is a graph of open clamp clearance over the rubber of the elastomeric stop ring.
Checks that the clamp can always be loose over the rubber and the spigot
   For easy installation
Expressed as a percentage
   Difference between the rubber OD when wrapped around a spigot OD and the ID an open clamp and the spigot OD, divided by the spigot OD
Measured when the clamp is completely open
   When the nut is at the tip of the bolt, where a small amount of weld retains it
Rubber thickness (t-d) taken into consideration
Tight open clamp
   Clearance below (0.5%
   Would make installation of the insertion stop more difficult
   Excessively loose open clamp
Clearance above 5%
Not critical suggests that the bolt is longer than necessary
The rubber might slip out of the clamp more easily during installation, but the user can always tighten the bolt partially to avoid this

The present invention also includes a method of joining and sealing a female plastic pipe end having a belled end with an end opening to a mating male plastic pipe end having an interior surface and an exterior surface, the method includes the steps of:

providing a sealing element in the form of an elastomeric sealing gasket, the gasket being installed within a groove formed adjacent the end opening in the belled pipe end of the female pipe section;

inserting the male pipe end into the end opening of the female pipe end so that the elastomeric sealing gasket makes sealing contact with the exterior surface of the male pipe end: and

providing a control mechanism for controlling the distance the male pipe end travels longitudinally within the end opening of the female plastic pipe end to thereby prevent overinsertion of the male pipe end within the female pipe opening, the control mechanism being an external stop provided on the exterior of the male plastic pipe end, the external stop being comprised of an elastomeric stop ring together with an associated clamp ring, the elastomeric stop ring having an interior surface and an exterior surface, the interior surface having an internal diameter which is selected to be closely received over the exterior surface of the male, spigot plastic pipe end so that the ring member frictionally engages the exterior surface.

An invention has been provided with several advantages. The stop ring of the invention uses frictional engagement with the exterior surface of the male, spigot pipe end rather than being fixed in position by set screws or glues, as was the case with certain of the prior art designs. This allows the present stop ring to resist a certain load and yet slide on the exterior pipe surface if the force exceeds a certain limit, thereby avoiding damaging the spigot or the socket. The stop ring of the invention is relatively simple in design and economical to manufacture and does not add greatly to the cost of the overall pipeline installation. It provides a reliable visual indication of the proper insertion position and avoids overinsertion due to a number of different situations which can be encountered during plastic pipeline installations.

While the invention has been shown in only one of its forms, it is not thus limited but is susceptible to various changes and modifications without departing from the spirit thereof.

What is claimed is:

1. A plastic pipe connection designed to prevent overinsertion of a male, spigot plastic pipe end within a mating female, belled plastic pipe end in forming sealed connections in pipeline installations, comprising:
a female plastic pipe end having a belled end with an end opening and a circumferential groove formed adjacent the end opening;
a mating male, spigot plastic pipe end having an interior surface and exterior surface;
a sealing element in the form of an elastomeric sealing gasket installed within the groove formed in the belled end of the female pipe section; and
a control mechanism for controlling the distance the male, spigot pipe end travels longitudinally within the end opening, of the female, belled plastic pipe end to thereby prevent overinsertion of the male pipe end within the female pipe end opening, the control mechanism comprising an external stop provided on the exterior of the male plastic pipe end, the external stop being made up of an elastomeric stop ring together with an associated clamp ring, the elastomeric stop ring having an interior surface and an exterior surface, the interior surface having an internal diameter which is selected to be closely received over the exterior surface of the male, spigot plastic pipe end so that the ring member frictionally engages the exterior surface.

2. The plastic pipe connection of claim 1, wherein the elastomeric stop ring frictional engagement on the exterior surface of the male, spigot plastic pipe end allows the stop ring to slip when a predetermined level of engagement force is exerted on the stop ring by the female pipe end during the assembly of the male pipe end and the female pipe end.

3. The plastic pipe connection of claim 2, wherein the elastomeric stop ring is formed of rubber,

4. The plastic pipe connection of claim 3, wherein the associated clamp ring is formed of steel.

5. The plastic pipe connection of claim 4, wherein the c amp ring is a hose clamp.

6. The plastic pipe connection of claim 3, wherein the elastomeric stop ring exterior surface has a circumferential recessed area formed between at least a leading lip region.

7. The plastic pipe connection of claim 6, wherein the elastomeric stop ring exterior surface has a U-shaped circumferential recessed area formed between a leading lip region and a trailing lip region.

8. The plastic pipe connection of claim 7, wherein the circumferential recessed area on the exterior surface of the elastomeric stop ring, forms a circumferential raceway for receiving the associated clamp ring.

9. The plastic pipe connection of claim 8, wherein the leading lip region of the elastomeric stop ring is connected by an outer vertical sidewall region to a base region of the elastomeric stop ring, and wherein the outer vertical sidewall region, together with the leading lip region, for a rubber region of sufficient thickness to act as a bumper when the belled plastic pipe end contacts the elastomeric stop ring.

10. A method of joining and sealing a female plastic pipe end having a belled end with an end opening to a mating male plastic pipe end having an interior surface and an exterior surface, the method comprising the steps of:
providing a sealing element in the form of an elastomeric sealing gasket, the gasket being installed within a groove formed adjacent the end opening in the belled pipe end of the female pipe section;
inserting the male pipe end into the end opening of the female pipe end so that the elastomeric sealing gasket makes sealing contact with the exterior surface of the male pipe end;
providing, a control mechanism for controlling the distance the male pipe end travels longitudinally within the end opening of the female plastic pipe end to thereby prevent overinsertion of the male pipe end within the female pipe opening, the control mechanism being an external stop provided on, the exterior of the male plastic pipe end, the external stop being comprised of an elastomeric stop ring together with an associated clamp ring, the elastomeric stop ring having an interior surface and an exterior surface, the interior surface having an internal diameter which is selected to be closely received over the exterior surface of the male, spigot plastic pipe end so that the ring member frictionally engages the exterior surface.

11. The method of claim 10, wherein the elastomeric stop ring frictional engagement on the exterior surface of the male, spigot plastic pipe end allows the stop ring to slip when a predetermined level of engagement force is exerted on the stop ring by the female pipe end during the assembly of the male pipe end and the female pipe end.

12. The method of claim 11, wherein the elastomeric stop ring is formed of rubber.

13. The method of claim 11, wherein the associated clamp ring is formed of steel.

14. The method of claim 13, wherein the clamp ring is a hose clamp.

15. The method of claim 10, wherein the elastomeric stop ring exterior surface has a circumferential recessed area formed between at least a leading lip region.

16. The method of claim 14, wherein the elastomeric stop ring exterior surface has a U-shaped circumferential recessed area formed between a leading lip region and a trailing lip region.

17. The method of claim 16, wherein the circumferential recessed area on the exterior surface of the elastomeric stop ring forms a circumferential raceway for receiving the associated clamp ring.

18. The method of claim 17, wherein the leading lip region of the elastomeric stop ring is connected by an outer vertical sidewall region to a base region of the elastomeric stop ring, and wherein the outer vertical sidewall region, together with the leading lip region, for a rubber region of sufficient thickness to act as a bumper when the belied plastic pipe end contacts the elastomeric stop ring.

19. The method of claim 10, wherein a companion restraint mechanism is provided for the elastomeric sealing ring which allows movement of the mating male pipe relative to the belled end of the female pipe in a first longitudinal direction but which restrains movement in a second, opposite relative direction.

20. The method of claim 19, wherein the restraint mechanism comprises a ring shaped housing having a circumferential interior region and a companion gripping insert which is delivered with and contained within the circumferential interior region of the housing, the gripping insert having an exterior surface and an interior gripping surface with at least one row of gripping teeth for gripping the exterior surface of the male plastic pipe end.
